(19) United States
(12) Patent Application Publication
(10) Pub. No.: US 2007/0229406 A1
(43) Pub. Date: Oct. 4, 2007

(54) Plasma display apparatus and method of driving the same

(75) Inventor: Seong Hak Moon, Seoul (KR)

Correspondence Address: KED & ASSOCIATES, LLP, P.O. Box 221200, Chantilly, VA, 20153-1200, US

(73) Assignee: LG Electronics Inc.

(21) Appl. No.: 11/730,689

(22) Filed: Apr. 3, 2007

(30) Foreign Application Priority Data
Apr. 4, 2006 (KR) 10-2006-0030589

(51) Int. Cl. G09G 3/28

(52) U.S. Cl. 345/60

(57) ABSTRACT

A plasma display apparatus is disclosed. The plasma display apparatus includes an electrode driver and a plasma display panel. The electrode driver supplies a first data pulse corresponding to an image to a first electrode, and supplies a second data pulse corresponding to the image to a second electrode. The plasma display panel includes the first electrode and the second electrode, displays the image in a first area for a reference time, and displays the image in a second area different from the first area after the reference time.

This application claims the benefit of Korean Patent Application No. 10-2006-0030589 filed on Apr. 4, 2006, which is hereby incorporated by reference.

### BACKGROUND

1. Field

This document relates to a plasma display apparatus and a method of driving the same.

2. Description of the Related Art

A plasma display apparatus comprises a plasma display panel and a driver. The plasma display panel comprises discharge cells partitioned by barrier ribs. When the driver supplies a driving signal to an electrode of the plasma display panel, a discharge occurs in the discharge cells such that phosphors inside the discharge cells are excited, and thus emitting light.

The plasma display apparatus represents a gray level by a combination of subfields. In other words, the plasma display apparatus emits light to the outside during each of the subfields, and the gray level is represented by a sum of the quantity of light emitted to the outside in each of the subfields.

Each subfield includes a reset period, an address period, and a sustain period. During the reset period, a state of wall charges distributed within all the discharge cells of the plasma display panel is uniform. During the address period, the discharge cells to emit light are selected. During the sustain period, light is emitted from the selected discharge cells.

### SUMMARY

In one aspect, a plasma display apparatus comprises an electrode driver that supplies a first data pulse corresponding to an image to a first electrode, and supplies a second data pulse corresponding to the image to a second electrode, and a plasma display panel that comprises the first electrode and the second electrode, displays the image in a first area for a reference time, and displays the image in a second area different from the first area after the reference time.

The reference time may be more than 0 and equal to or less than 300 seconds.

The image may comprise at least one of a figure, characters, a logo or a sign.

The first area and the second area may be separated from each other.

An attribute of the image displayed in the first area may be different from an attribute of the image displayed in the second area.

The attribute may comprise at least one of a color of the image, bitmap of the image or a background color of the image.

In another aspect, a plasma display apparatus comprises a signal separation unit that separates a video information signal and a symbol information signal, a signal detection unit that outputs a first symbol position signal extracted from the symbol information signal input from the signal separation unit, a position discrimination unit that outputs the first symbol position signal for a reference time and outputs a second symbol position signal after the reference time, a video signal processor that receives the video information signal output from the signal separation unit and the first symbol position signal or the second symbol position signal output from the position discrimination unit, and outputs a first video signal or a second video signal, an electrode driver that supplies a first data pulse corresponding to the first video signal to a first electrode, and supplies a second data pulse corresponding to the second video signal to a second electrode, and a plasma display panel that comprises a first electrode and a second electrode, displays a symbol in a first area for the reference time, and displays the symbol in a second area different from the first area after the reference time.

The symbol may comprise at least one of a logo, characters, a figure or a sign.

The first area and the second area may be separated from each other.

An attribute of the symbol displayed in the first area may be different from an attribute of the symbol displayed in the second area.

The attribute may comprise at least one of a color of the symbol, bitmap of the symbol or a background color of the symbol.

The plasma display apparatus may further comprise a memory that stores symbol position data corresponding to the first symbol position signal, wherein the position discrimination unit may compare the first symbol position signal with the symbol position data, and then discriminate whether the symbol is or not displayed for the reference time.

The reference time may be more than 0 and equal to or less than 300 seconds.

In still another aspect, a method of driving a plasma display apparatus comprising a first electrode and a second electrode, the method comprises separating a video information signal and a symbol information signal from a received broadcasting signal, outputting a first symbol position signal extracted from the symbol information signal, outputting the first symbol position signal for a reference time and a second symbol position signal after the reference time, receiving the video information signal and the first or second symbol position signal, and outputting a first video signal or a second video signal, supplying a first data, pulse corresponding to the first video signal to the first electrode to display a symbol in a first area for the reference time, and supplying a second data pulse corresponding to the second video signal to the second electrode to display the symbol in a second area different from the first area after the reference time.

The symbol may comprise at least one of a logo, characters, a figure or a sign.

The first area and the second area may be separated from each other.

An attribute of the symbol displayed in the first area may be different from an attribute of the symbol displayed in the second area.

The attribute may comprise at least one of a color of the symbol, bitmap of the symbol or a background color of the symbol.

The reference time may be more than 0 and equal to or less than 300 seconds.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention.

FIG. 1 illustrates a plasma display apparatus according to one embodiment; and

FIG. 2 illustrates an image displayed by the plasma display apparatus according to one embodiment.

### DETAILED DESCRIPTION OF EMBODIMENTS

Reference will now be made in detail embodiments of the invention examples of which are illustrated in the accompanying drawings.

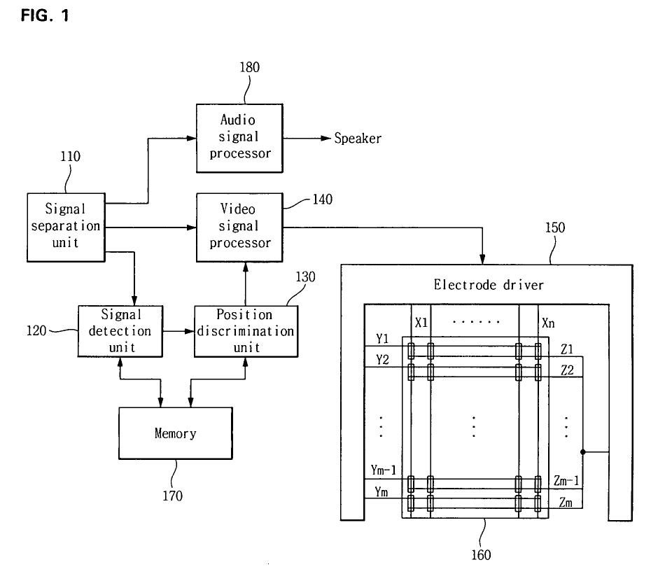

FIG. 1 illustrates a plasma display apparatus according to one embodiment. As illustrated in FIG. 1, the plasma display apparatus according to one embodiment comprises a signal separation unit 110, a signal detection unit 120, a position discrimination unit 130, a video signal processor 140, an electrode driver 150, and a plasma display panel 160.

The signal separation unit 110 separates a video information signal and a symbol information signal.

The signal detection unit 120 outputs a first symbol position signal extracted from the symbol information signal.

The position discrimination unit 130 outputs the first symbol position signal input for a reference time, and outputs a second symbol position signal after the reference time.

The video signal processor 140 receives the video information signal output from the signal separation unit 110, and the first symbol position signal or the second symbol position signal output from the position discrimination unit 130, thereby outputting a first video signal or a second video signal.

The electrode driver 150 supplies a reset pulse for uniforming a state of wall charges distributed within all of discharge cells to scan electrodes Y1 to Ym during a reset period.

The electrode driver 150 supplies a first data pulse corresponding to an image to a first electrode, and a second data pulse corresponding to the image to a second electrode. In other words, the electrode driver 150 supplies the first data pulse corresponding to a first video signal to the first electrode, and the second data pulse corresponding to a second video signal to the second electrode. The electrode driver 150 supplies a scan pulse corresponding to the first data pulse and the second data pulse to the scan electrodes Y1 to Ym. The discharge cells to emit light are selected according to the supply of the first data pulse, the second data pulse, and the scan pulse. The electrode driver 150 alternately supplies a sustain pulse to the scan electrodes Y1 to Ym and sustain electrodes Z1 to Zm, thereby causing the selected discharge cells to emit light.

The plasma display panel 160 comprises the first electrode and the second electrode intersecting the scan electrodes Y1 to Ym and the sustain electrodes Z1 to Zm. The first electrode and the second electrode are included in address electrodes X1 to Xn. An intersection area of the scan electrodes Y1 to Ym and the sustain electrodes Z1 to Zm and the first or second electrode corresponds to the discharge cell. The plasma display panel 160 displays the image in a first area for the reference time, and displays the image in a second area different from the first area after the reference time. The image may correspond to a symbol. In other words, the plasma display panel 160 comprises the first electrode and the second electrode. The plasma display panel 160 displays the symbol in the first area for the reference time, and the symbol in the second area different from the first area after the reference time. The symbol may comprise at least one of a logo, a figure, characters or a sign.

In a case where the plasma display panel 160 continuously displays the image in the first area, there may be a deterioration of a phosphor within the discharge cell corresponding to the first area or image sticking caused by priming particles remaining in the discharge cell corresponding to the first area. Accordingly, the plasma display panel 160 displays the image in the first area for the reference time, and the image in the second area different from the first area after the reference time, thereby preventing the occurrence of image sticking.

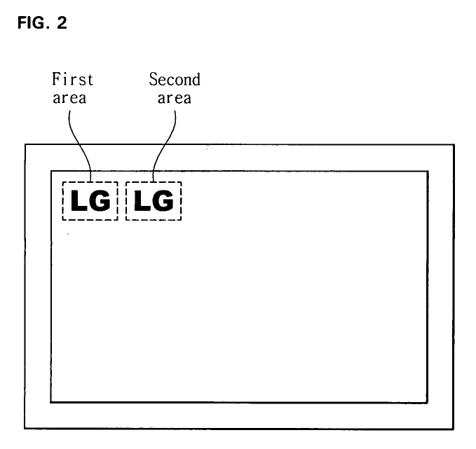

The following is a detailed description of an operation of the plasma display apparatus with reference to FIGS. 1 and 2.

The signal separation unit 110 receives a broadcasting signal from the outside, and separates a video information signal, a horizontal synchronization signal, a vertical synchronization signal, a clock signal, an audio information signal, and a symbol information signal from the broadcasting signal. The symbol information signal may include information about characters of a broadcast program. The symbol information signal may be a signal for teletext. The audio information signal is output to a speaker through an audio signal processor 180.

The signal detection unit 120 extracts the first symbol position signal and a first symbol attribute signal from the symbol information signal to output them to a memory 170. The memory 170 stores information about the first symbol position signal and information about the first symbol attribute signal. The information about the first symbol position signal includes information regarding to a position of the first area of the plasma display panel 160 displaying an image such as a symbol. The information about the first symbol attribute signal may comprise at least one of information about a color, bitmap or a background color of the symbol.

The position discrimination unit 130 outputs the first symbol position signal for the reference time, and the second symbol position signal after the reference time. In other words, the position discrimination unit 130 compares a position and an attribute of the symbol extracted from the first symbol position signal and the first symbol attribute signal output to the memory 170 with a position and an attribute of the symbol previously stored in the memory 170. When the position discrimination unit 130 discriminates that the same symbol is displayed in the same position for the reference time, the first symbol position signal and the first symbol attribute signal are output to the video signal processor 140. Further, when the position discrimination unit 130 discriminates that the same symbol is continuously displayed in the same position after the reference time, the second symbol position signal and a second symbol attribute signal are output to the video signal processor 140.

Even if the same symbol is displayed in the same position (i.e., the first area) for the reference time, image sticking does not occur in the plasma display apparatus. Therefore, the position discrimination unit 130 outputs the first symbol position signal and the first symbol attribute signal to the video signal processor 140. However, when the same symbol is continuously displayed in the first area after the reference time, there is a great likelihood of the occurrence of image sticking in the plasma display apparatus. Therefore, the position discrimination unit 130 outputs the second symbol position signal and the second symbol attribute signal corresponding to the second area different from the first area to the video signal processor 140. When the reference time is more than 0 and equal to or less than 300 seconds, the image sticking is prevented.

A portion of the first area may overlap a portion of the second area. Further, the first area and the second area may be separated from each other. The first symbol attribute signal and the second symbol attribute signal may be different from each other. When the first symbol attribute signal is different from the second symbol attribute signal, the occurrence of image sticking is restrained.

The video signal processor 140 performs an inverse gamma correction process, a half toning process, a subfield mapping process, and a data arrangement process on the video information signal output from the signal separation unit 110, the first or second symbol position signal, and the first or second symbol attribute signal to output the first video signal or the second video signal to the electrode driver 150.

The video signal processor 140 receives the horizontal synchronization signal, the vertical synchronization signal, and the clock signal output from the signal separation unit 110, and then outputs a timing signal to the electrode driver 150. The timing signal makes the electrode driver 150 to supply the scan pulse, the first data pulse corresponding to the first video signal, the second data pulse corresponding to the second video signal, and the sustain pulse to the scan electrodes Y1 to Ym, the first electrode, the second electrode, and the sustain electrodes Z1 to Zm, respectively.

The electrode driver 150 supplies the first or second data pulse in response to the timing signal of the video signal processor 140 and the first or second video signal to the first or second electrode. Therefore, as illustrated in FIG. 2, the supplying of the first or second data pulse and the scan pulse allows the image such as the symbol to be displayed in the first area or the second area. The first area may be shifted from the second area by a predetermined pixel.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display apparatus comprising:
an electrode driver that supplies a first data pulse corresponding to an image to a first electrode, and supplies a second data pulse corresponding to the image to a second electrode; and
a plasma display panel that comprises the first electrode and the second electrode, displays the image in a first area for a reference time, and displays the image in a second area different from the first area after the reference time.

2. The plasma display apparatus of claim 1, wherein the reference time is more than 0 and equal to or less than 300 seconds.

3. The plasma display apparatus of claim 1, wherein the image comprises at least one of a figure, characters, a logo or a sign.

4. The plasma display apparatus of claim 1, wherein the first area and the second area are separated from each other.

5. The plasma display apparatus of claim 1, wherein an attribute of the image displayed in the first area is different from an attribute of the image displayed in the second area.

6. The plasma display apparatus of claim 5, wherein the attribute comprises at least one of a color of the image, bitmap of the image or a background color of the image.

7. A plasma display apparatus comprising:
a signal separation unit that separates a video information signal and a symbol information signal;
a signal detection unit that outputs a first symbol position signal extracted from the symbol information signal input from the signal separation unit;
a position discrimination unit that outputs the first symbol position signal for a reference time and outputs a second symbol position signal after the reference time;
a video signal processor that receives the video information signal output from the signal separation unit and the first symbol position signal or the second symbol position signal output from the position discrimination unit, and outputs a first video signal or a second video signal;
an electrode driver that supplies a first data pulse corresponding to the first video signal to a first electrode, and supplies a second data pulse corresponding to the second video signal to a second electrode; and
a plasma display panel that comprises a first electrode and a second electrode, displays a symbol in a first area for the reference time, and displays the symbol in a second area different from the first area after the reference time.

8. The plasma display apparatus of claim 7, wherein the symbol comprises at least one of a logo, characters, a figure or a sign.

9. The plasma display apparatus of claim 7, wherein the first area and the second area are separated from each other.

10. The plasma display apparatus of claim 7, wherein an attribute of the symbol displayed in the first area is different from an attribute of the symbol displayed in the second area.

11. The plasma display apparatus of claim 10, wherein the attribute comprises at least one of a color of the symbol, bitmap of the symbol or a background color of the symbol.

12. The plasma display apparatus of claim 7, further comprising a memory that stores symbol position data corresponding to the first symbol position signal,
wherein the position discrimination unit compares the first symbol position signal with the symbol position data, and then discriminates whether the symbol is or not displayed for the reference time.

13. The plasma display apparatus of claim 7, wherein the reference time is more than 0 and equal to or less than 300 seconds.

14. A method of driving a plasma display apparatus comprising a first electrode and a second electrode, the method comprising:
separating a video information signal and a symbol information signal from a received broadcasting signal;
outputting a first symbol position signal extracted from the symbol information signal;
outputting the first symbol position signal for a reference time and a second symbol position signal after the reference time;
receiving the video information signal and the first or second symbol position signal, and outputting a first video signal or a second video signal;
supplying a first data pulse corresponding to the first video signal to the first electrode to display a symbol in a first area for the reference time; and
supplying a second data pulse corresponding to the second video signal to the second electrode to display the symbol in a second area different from the first area after the reference time.

15. The method of claim 14, wherein the symbol comprises at least one of a logo, characters, a figure or a sign.

16. The method of claim 14, wherein the first area and the second area are separated from each other.

17. The method of claim 14, wherein an attribute of the symbol displayed in the first area is different from an attribute of the symbol displayed in the second area.

18. The method of claim 17, wherein the attribute comprises at least one of a color of the symbol, bitmap of the symbol or a background color of the symbol.

19. The method of claim 14, wherein the reference time is more than 0 and equal to or less than 300 seconds.
